(19) United States
(12) Patent Application Publication
(10) Pub. No.: US 2009/0199812 A1
(43) Pub. Date: Aug. 13, 2009

(54) Structure of the rotary engine

(76) Inventor: Jung Kuang Chou, Panchiao City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/382,585

(22) Filed: Mar. 19, 2009

Related U.S. Application Data
(63) Continuation-in-part of application No. 11/649,308, filed on Jan. 4, 2007.
Application No. 11/649,308 is a continuation-in-part of application No. 11/114,059, filed on Apr. 26, 2005, now abandoned.
Application No. 11/114,059 is a continuation-in-part of application No. 10/900,192, filed on Jul. 28, 2004, now abandoned.
Application No. 10/900,192 is a continuation-in-part of application No. 10/392,859, filed on Mar. 21, 2003, now abandoned.

(30) Foreign Application Priority Data
Jan. 23, 2009 (TW) 098102709

(51) Int. Cl. F02B 53/12; F02B 53/04

(52) U.S. Cl. 123/210; 123/228

(57) ABSTRACT

An improvement structure of the rotary engine mainly includes three parts. One is that at least a combustion chamber and an outlet are set on the perimeter of a steam wheel/flywheel. Under the optimum condition, a propelling chamber is set additionally in the front of combustion; chamber, and a platform is elongated in the rear for lasting the thrust force then driving out the exhaust gas. There is an explosion per rotation, and it also can be designed to be multiple explosions per rotation. And, an explosion chamber is set on the slide block in the outer side of steam wheel/flywheel and supported on the frame through screws. Besides it is able to adjust the advanced sparking time of inletting, the rest strokes except of aforementioned combustion chamber are all set with protruding faces on top to block the inlet to prevent the entering of flammable gas. The major characteristics of the present invention are that the aforementioned combustion chamber is moving type capable of adjusting a longer combustion time to create a larger explosion force, the exhausted gas has to be driven out to raise the pressure differential after each explosion, and the protruding face is used to control the inletting. Another is that an inward-concaved inclination angle and screws is used to replace the roller to support the slide blocks in the prior case. And, the last, airtight devices are set on three directions of the rim in the jointing face between steam wheel/flywheel and slide block.

This application is a continuation-in-part of U.S. patent application Ser. No. 11/649,308 filed on 4 Jan. 2007, which is a continuation-in-part of U.S. application Ser. No. 11/114,059 filed on 26 Apr. 2005, which is a CIP of U.S. application Ser. No. 10/900,192 filed on 28 Jul. 2004 being a continuation-in-part of U.S. application Ser. No. 10/392,859 filed on 21 Mar. 2003, which had claimed priority on Taiwanese application filed on 3 Apr. 2002.

### PRIOR ART OF THE INVENTION

The object of invention in the related prior case of rotary engine is emphasizing in solving the linking problem between the steam wheel/flywheel and slide block that can automatically adjust the variation created by the expansion on heating and contraction on cooling then the eliminate the obstacle and bottle neck. There are no studies and researches for the engine power. The prior case should belong to the heavy type of engine similar to the jet engine. The main exserted power is produced during the period of increasing pressure. It is applied to continuous and non-interrupted combustion to create thrust force that is larger and continuous. The speed is slow, the torque is large, and the fuel consumption is higher. If based on the traditional method, the intermittent combustion utilizes the high-pressured gas. The gas is quickly expanding after instantaneous explosion then creating the thrust force. The pressure-down stroke is applied to create the thrust force. Although the torque is smaller, the response speed is faster and more practical. It belongs to the light type of engine.

### SUMMARY OF THE INVENTION

The concept of present invention is based on the main structure and theory of the traditional reciprocating engine. The traditional cylinder is similar to the slide block in the prior case that is not moved in fixed space, and both pistons are also movable types. The different point is that the gas after the explosion in the traditional cylinder can expand in space and the exhausted gas can be driven out completely, but the other expansion of gas is limited to fixed space thus the driven-out of gas is not complete. The high-pressured exhausted gas has high density and is slow in responding speed, and it will offset and buffer the action force such that the explosive force is affected. In order to retrieve this defect, it is provided that the front is a propelling chamber and the rear is an outlet in the present invention beside a combustion chamber. The top of the front and rear two spaces are both set with a protruding rim to block up an inlet such that the space is reserved for gas expansion and propelling in the front while exploding, and for driving out the exhausted gas of explosion chamber in the rear. The outlet has to always keep opened with outside. The outer side of a steam wheel/flywheel is supported by screws and set with more than one slide blocks, and is set with an explosion chamber inside. While rotating, an exploding space is provided for the high-pressured gas of combustion chamber, and the high-pressured gas is guided into the propelling chamber to create the thrust force. The combustion chamber can also create the thrust force then the exhausted gas is driven out from the outlet. The above is called a cycle. Per rotation of the steam wheel/flywheel can also be designed to be multiple cycles. The aforementioned combustion chamber has no limitation in shapes, and it is better to have wide and shallow opening generally such that there are fast expansion, response, escape, and speed of high-pressured gas, and the created pressure differential can be large thus the large thrust force. But, it should be worked in a closed chamber while exploding. As for the traditional engine, the advanced sparking time is limited within the five degree space out of 360 degrees. However, the advanced sparking time of present invention can be arbitrarily adjusted without limitation. It is foreseen to obtain higher pressure before explosion. Besides, the heat contained in the exhausted gas can be recycled through the heat exchanger for warming usage while inletting. Furthermore, the temperature of cooling water can be slightly raised to become steam and turn into the kinetic energy of engine. The above are the following prospects of present invention. The second part of present invention is to use an inward-concaved inclination angle and screws to replace the roller in the prior case for better precision support of the slide blocks and capable of fine-regulation. The third part of present invention is surrounded and set with airtight devices on three sides of the rim in the jointing face between steam wheel/flywheel and slide block except the exhausted gas end.

### BRIEF DESCRIPTION OF THE DRAWINGS

FIG. 1 is a sectional plan diagram of the device according to the present invention.

FIG. 2 is a three-dimensional analytic diagram of the main part in the present invention.

FIG. 3 is a three-dimensional assembling diagram of the present invention.

FIG. 4 is a vector diagram of the explosion force in the present invention.

FIG. 5 is a displacement structure diagram of the high-voltage electrode.

### DETAILED DESCRIPTION OF THE PREFERRED EMBODIMENT

The rotary engine must achieve to be a light type and thus be more practical. But, in the prior case, it needs further to overcome a closed pocket theory before achieving. Therefore, the object of present invention is to eliminate the defect of mutual neutralization in action force and reaction force while exploding. It has already been found out in the experiment that the explosion sound is large but there is no thrust force. The solution is to guide the airflow in the reverse direction then turn them to the forward direction, and eliminate the pressure of exhausted gas to raise the pressure differential. Furthermore, the combustion chamber can be moving type and the length of advanced igniting time can be adjusted such that the pressure is strengthened to create the maximum explosion force. The present invention. adopts. an intermittent type of operation according to the traditional engine's method. There are more than one combustion chambers designated on the steam wheel/flywheel. During operation, the. inletting, sparking, exploding, and exhausting separately proceed at different fixed positions. The gas flow is guided in a propelling chamber from an explosion chamber while exploding, and the combustion chamber creates the thrust force at the same time. The gas flow should be guided toward to the front after exploding, that is, the rotating direction of steam wheel/flywheel body, and it can have the thrust force. While it is guided toward to the rear, it is limited to be driven out into the atmosphere. It should avoid touching the steam wheel/flywheel body, otherwise the thrust force will be mutually neutralized. The outlet in the rear is used for eliminating the exhausted gas, and its space has to always keep opened with outside. The gas pumping-out and exhausting facilities can be added while it is necessary to increase the exhausting effect. Beside the aforementioned combustion chamber, the top of propelling chamber and outlet are all set with protruding faces to block the inlet to prevent the entering of mixing gas. The protruding face at said site can also be designed as curve-bending seal to increase the air-tightness. The best configuration of the present invention is to construct a cycle, that is, exploding once by at least three strokes. Per rotation of steam wheel/flywheel can be designed to be one time explosion. Depending on the requirement, it can also be a multiple times explosion. The second part of the present invention is to use an inward-concaved inclination angle and screws to replace the roller in the prior case for better precision, wear resistance and with ease of fine-regulation the no-gap error. While exploding, the action force pushes the steam wheel/flywheel to rotate along the clockwise direction and the reaction force pushes the slide block rotate along the counter clockwise direction. Besides the resistance of screws, it also sustains simultaneously at side face a partial force supporting the tight fit between the slide block and steam wheel/flywheel. Further, since the displacement of supporting point in the slide block relative to screws caused by the expansion on heating and contraction on cooling is very minor, the outward protruded circular sliding path is replaced by more than two inclination angles with inward concaved outer rims. The volume of slide block can thus be reduced. The aforementioned inclination angle and the steam wheel/flywheel construct an inclined angle, the pressure between the slide block and steam wheel/flywheel is expected to approach to zero for the reduction in the friction resisting force and power loss. The magnitude of pressure in between is inverse proportional to the said inclined angle. The degree of slant in the inclination angle largely affects the output engine power, thus it is required to select a proper inclined angle. The third part of the present invention is to set the airtight devices on the remaining three directions of the rim except the exhausted gas end in the perimeter of jointing sites between steam wheel/flywheel and slide block. Two sides are set with circular layers and pressured by springs. Another end is lodged in the concaved sites of the slide block by a circular plate and pressured by springs. The bottom part close to inner side of circular plate is set with inclination face to raise the airtight effect at the said site. Theoretically, the steam wheel/flywheel and slide block should be tightly fit by the concentric circles. In reality, the aforementioned disposal is necessary since there will be deformation after expansion on heating and contraction on cooling.

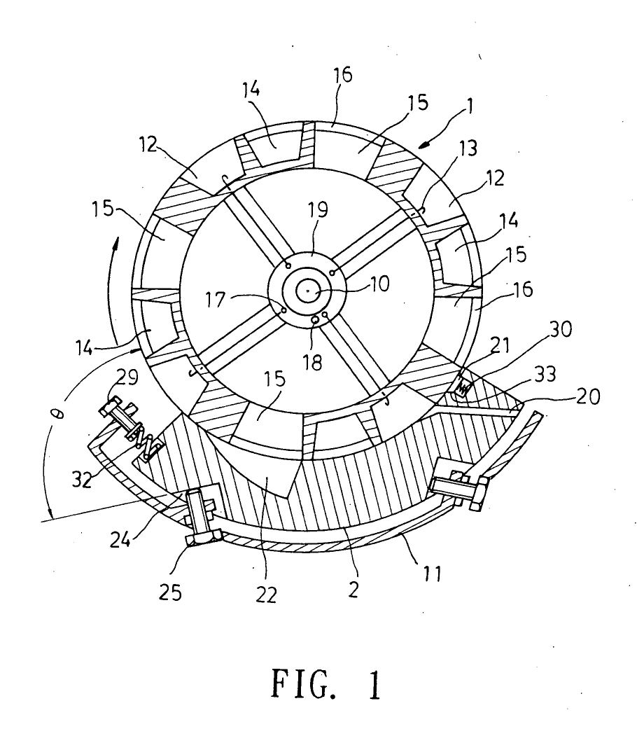

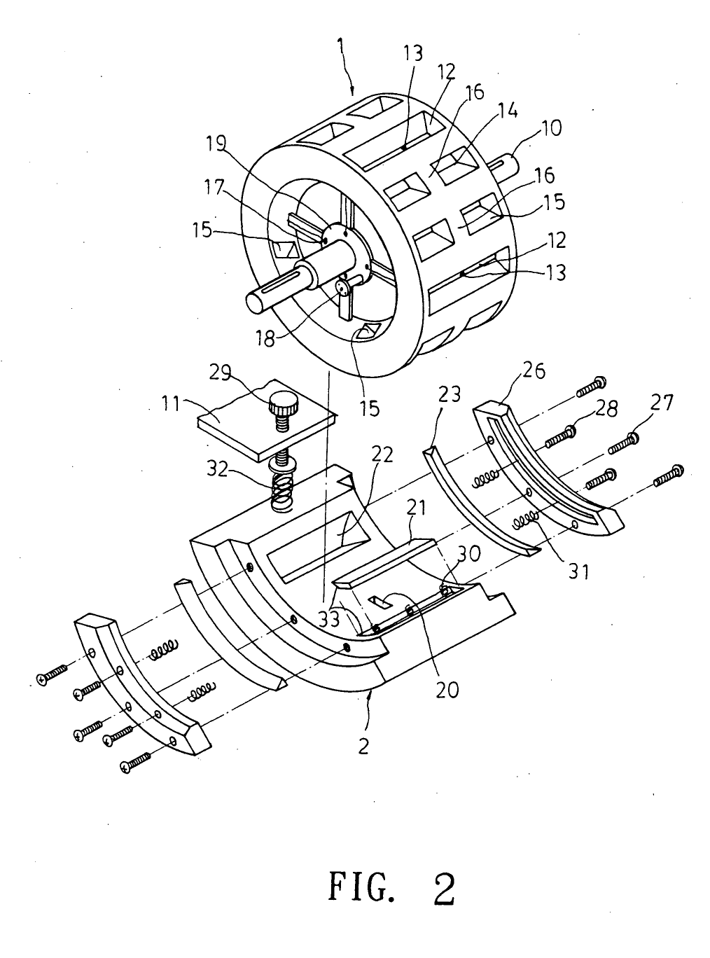

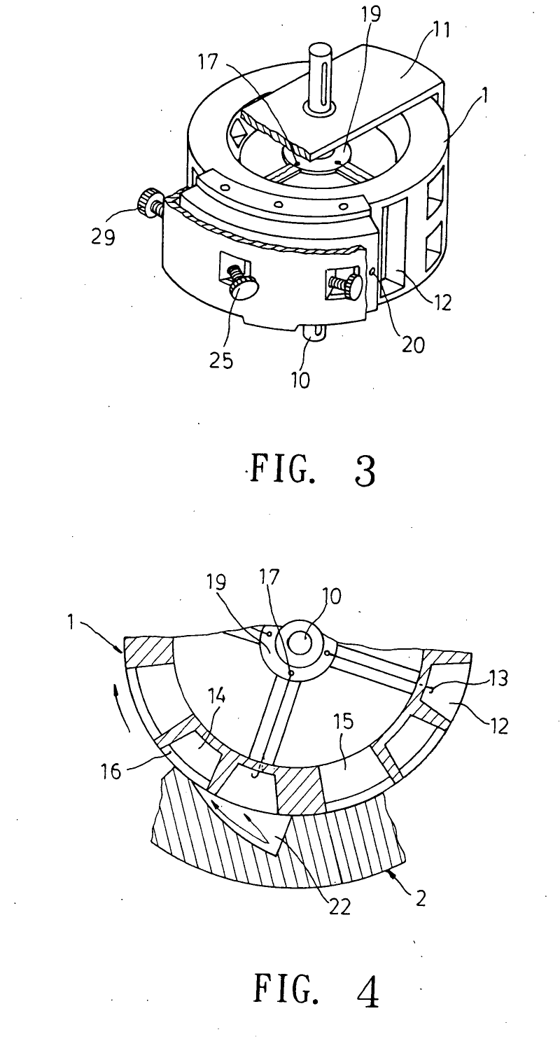

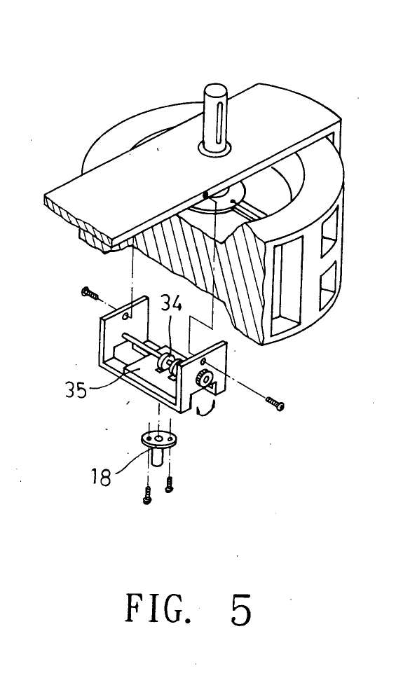

It is to be understood that the engine structure according to the present invention is to exclude the compression stroke in the four strokes of traditional engine. Therefore, the fuel, mixing gas, high-pressured air, and so on are all required to be supplied by outside. Please refer to FIG. 1 to 5 or selecting an air compressor with proper capacity to match with the present engine. Two ends of main shaft 10 are fixed to the frame by bearings to transmit/drive. The fuel and air are guided in. The high-pressured mixing gas is linked and output to the inlet 20 of present engine. During the operation, the mixing gas can only fill into the combustion chamber 12, the top of remaining propelling chamber 14 and outlet 15 are all set with protruding faces 16 to stop the inlet 20 to prevent the input. The combustion chamber 12 is equipped with spark plugs 13 inside and set with the distributor 19 outside that is fixed on the steam wheel/flywheel 1. Following by the rotation of steam wheel/flywheel and the touch with high voltage electrode 18, the spark plugs 13 are discharged and the combustion chamber 12 is beginning to ignite. The high voltage electrode 18 is fixed on the frame and can only adjust the displacement to front or rear to change the length of burning time. If it is expected to have ultra long burning time, the distance from the inlet 20 to explosion chamber 22, that is, the length of slide block 2 should be designed to be lengthened. There will be a gas exploding effect while the combustion chamber 12 arrives on top of explosion chamber 22. The gas is quickly expanded to create the thrust, and the combustion chamber 12 and propelling chamber 14 are pushed to forwardly rotate. Then the exhausted gas inside the explosion chamber 22 is eliminated through the outlet 15 to avoid the remained gas pressure to neutralize the force of next explosion. By repeating the above operation many times, the slide block 2 is supported the reaction force through the inward-concaved inclination angle 24 and screws 25. The slide block 2 will be drawn out along the rotating direction by the steam wheel/flywheel 1 while expanding, and will be pushed back to the original position by springs 32 while contracting. The pressure of spring 32 is adjusted by screw 29. The said method will not be jammed and need no water-cooling device. The temperature of steam wheel/flywheel 1 may be high, while it is necessary, it can change to adopt a direct injecting cylinder to provide the fuel and lower the supply of air pressure for the consideration of increasing the burning time. The present invention adopts a direct driving to main shaft, and there is no mechanical power loss. By enlarging the radius of gyration, it only needs very small gas pressure then the huge torque can be obtained according to the principle of lever and the relative speed becomes slower. A steam wheel/flywheel can also collocate two slide blocks simultaneously. A first group of gas source can vary the speed and a second group of gas source can increase the horsepower, and an electromagnetic valve is planned to be setup in between to be electrical power controlled. As. for the airtight devices between the steam wheel/flywheel slide block, please refer to those shown in FIG. 2. Two sides are lodged in a supporting element 26 separately by a circular layer 23 and springs 31, then fixed at two sides of the slide block 2 by screws 27 bilaterally. Following by pushing the pressure on springs 31 by screws 28, the circular layer 23 is pushed to fit tightly with two sides of the slide block 2.

I claim:

1. An improvement structure of the rotary engine including:
at least a combustion chamber and an outlet set on the perimeter of a steam wheel/flywheel, a platform elongated in between to last the thrust force and prevent the reverse flowing of gas, and a propelling chamber set additionally in the front of combustion chamber under the optimum condition; wherein they can be repeated set in series, the combustion chamber proceeds separately the inletting, sparking, exploding strokes at fixed positions during operation, there are more than one slide blocks set in the outer side of steam wheel/flywheel, an airtight device is set on the outer rim of two jointing faces with an explosion chamber set inside to guide the high-pressured gas of combustion chamber into the propelling chamber, the remaining exhausted gas is driven out from the outlet, the mixing gas are prevented from entering the propelling chamber and outlet through the protruding faces.

2. The combustion chamber according to claim 1, which is a moving type with spark plugs set inside, the electrical power is delivered by the external high voltage electrodes through the contact of a distributor or discharge, the high voltage electrodes can move their locations to the front or rear to change the advanced spark time and increase the explosion force.

3. The outlet according to claim 1, which can be pushed away by the slide block or replaced by setting an outlet on its top.

4. The slide block according to claim 1, which is mainly characterized in that more than two inward-concaved inclination angles are set on its outer rim and separately fixed to the frame by screws for supporting to resist the reacting force created while exploding, the said inclination angles and steam wheel/flywheel construct an included angle, the proper angle can keep a tight fit between the steam wheel/flywheel and the slide block, and the pressure is approaching to zero to reduce the power loss.

5. The airtight devices according to claim 1, which are set on the remaining three directions of the rim except the exhausted gas end in the jointing sites between steam wheel/flywheel and slide block, two sides are set with circular layers and pressured by springs, another end is lodged in the concaved sites of the slide block by a circular plate and pressured by springs.
